(19) United States
(12) Patent Application Publication
(10) Pub. No.: US 2004/0021243 A1
(43) Pub. Date: Feb. 5, 2004

(54) METHOD FOR MANUFACTURING AUXILIARY GAS-ADDING POLYURETHAE/POLYURETHANE-UREA POLISHING PAD

(76) Inventors: Wen-Chang Shih, Taichung (TW); Yung-Chung Chang, Taipei (TW); Min-Kuei Chu, Taichung (TW); Lung-Chen Wei, Taichung (TW); Wen-Pin Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,255

(22) Filed: Mar. 27, 2003

(30) Foreign Application Priority Data
Aug. 2, 2002 (TW) 91117406

(51) Int. Cl. B29C 44/02

(52) U.S. Cl. 264/51; 264/85; 264/53

(57) ABSTRACT

A method for manufacturing a PU (polyurethane) polishing pad is provided. Resins containing active hydrogen functional groups such as polyol resins, polyamine resins, and polythiol resins, and polyisocyanate resins containing —NCO functional groups are mixed to form a foamed PU polishing pad with excellent polishing properties by reaction injection-molding under high pressure, low temperature and auxiliary gas-adding. The PU polishing pad in accompany with an abrasive slurry can be widely used to polish high-level products such as wafers and optical glass.

### CROSS REFERENCE TO RELATED APPLICATIONS

This application claims the priority benefit of Taiwan application serial no. 91117406, fixed Aug. 02, 2002.

### BACKGROUND OF INVENTION

1. Field of the Invention

The present invention relates to methods for manufacturing polyurethanes (PUs) and polyurethane-ureas (PURs) polishing pads, and more particularly, to a method for fabricating a multi-functional microcellular PUs and PURs polishing pad for use to polish wafers and optical lenses.

2. Background of the Invention

To fabricate semiconductor devices such as memory wafer or logic wafer, it is intended to increase aspect ratios and conductive circuit layers for achieving high density of electronic components and reduction in fabrication costs. However, for such a multi-layer conductive circuit structure, with increase in number of the conductive circuit layers, corrugation and unevenness of wafer surfaces would become more substantial. In order to form more conductive circuit layers and to assure production yield, it is therefore highly desirable to eliminate surface unevenness and achieve global planarity for wafers. This technology has been originally proposed by IBM in U.S.A., wherein a chemical mechanical polishing (CMP) process is applied to damascene for fabricating embedded conductive circuits. Basically, during the CMP process, surface evenness is conducted by the effect of relative motion between the slurry having suspended abrasive particles and a polishing pad of suitable elasticity and hardness on wafers. When the polishing pad moves and presses on wafer surfaces, abrasive particles of the slurry in frictional contact with the wafer surfaces lead to the wafers having abrasive loss. Physical properties such as softness, hardness and roughness of the polishing pad would affect irregular interaction among abrasive particles in the slurry in horizontal and vertical directions. Under a certain pressure, horizontal moving force of the polishing pad plays an important role in quality of wafer planarity. In the CMP process, pressure from a polishing head is applied through the polishing pad to the wafer surfaces for maintaining planarity during polishing and uniform distribution of abrasive particles in the slurry is also a critical factor for uniformity of polished surfaces. Therefore, the polishing pad must be sufficiently rigid for polishing purpose and porous for holding the slurry. In general, larger pores in the polishing pad facilitate uniform distribution of abrasive particles in the slurry, and help accommodate polish-produced dross and ineffective slurry. However, too large pores make the polishing pad hardly achieve constant polishing pressure, resulting in low planarity of polished surfaces.

After the polishing pad is used for a certain period of time, with polishing-produced dross and abrasive particles being deposited in the pores of the polishing pad, a conditioning process is performed for scraping or brushing the polishing pad, so as to clean off the deposits. When the polishing pad starts to be “glazing” and is hardly restored with its polishing function by the conditioning process, the polishing pad cannot be used any longer. Therefore, it is greatly desirable to enhance lifetime of the polishing pad in consideration of cost reduction and production yield.

U.S. Pat. No. 3,284,274 teaches the use of a porous material for polishing purpose. U.S. Pat. No. 4,841,680 (Rodel company, 1989) discloses a wet PU polishing pad with vertically inverted pores. This polishing pad is fabricated through the use of conventional solvent/non-solvent polymer coagulation technology. First, polyols and isocyanates are reacted at 80° C. and then dissolved in N,N′-dimethylformamide (DMF) to form a polymer solution. A substrate is coated with the polymer solution and dipped into a water bath for fully and sufficiently coagulating polymer. Then, another solvent e.g. water is used to replace the original solvent i.e. DMF, and the coagulated polymer is treated with high temperature and dried to evaporate remaining solvent therein, so as to form irregularly shaped pores for the polymer. U.S. Pat. No. 6,095,902 (Rodel company, 2000) discloses a porous elastic wet PU polishing pad based on copolymer of polyether polyols and polyester polyols, or on more than three types of polyols. These two patents both relate to a method of using another solvent or high temperature to eliminate remaining original solvent, so as to form polymer with non-uniform internal pores. The polymer is surface-removed by using a blade or a rotating mill to exposeinternal pores thereof; then, the polymer is affixed to a substrate to form a polishing pad, or alternatively, the polymer is foamed in a mold to form a cake, and then cut into single pieces to be attached to substrates for forming polishing pads. However, such polishing pads are fabricated by complex and labor-consuming processes, such as formation of PU foam polymer, surface removal/singulation and attachment to substrates. And, the processes of surface removal/singulation are not easily controlled, thereby possibly leading to problems of poor uniformity of pores, small surface openings of the pores (i.e. pore bottom larger in diameter than surface opening), increased proportion of pore walls in working surfaces for the polishing pads. This would be detrimental to polishing stability of the polishing pads, such as unpredictable lifetime, uneven contact between slurry particles and surfaces to be polished, and the like.

U.S. Pat. No. 5,578,362 (Rodel company, 1996) discloses a polishing pad comprising a polymeric matrix impregnated with a plurality of hollow, flexible, organic polymeric microelements. This polishing pad has a work surface and a subsurface proximate to the work surface. One portion of the polymeric microelements at the work surface is exposed to the working environment and accommodates a polishing slurry, and another portion of the polymeric microelements embedded within the subsurface is not exposed to the working environment. The work surface becomes relatively softer than the subsurface due to exposure of the polymeric microelements at the work surface to the working environment. When the work surface is worn away during the use of the polishing pad, the polymeric microelements embedded in the subsurface are adapted to be exposed to the working environment, thereby making the subsurface become a new work surface with consistent polishing characteristics. However, fabrication of the above polishing pad needs to undergo steps of mixing a polymeric matrix, blending hollow elastic polymeric microspheres, transferring the mixture to a mold, curing the mixture at a temperature relatively higher than normal temperature, cooling the mixture, treating or chemically modifying the work surface, and the like. Such a fabrication method is not only time-consuming but also hard to retain stable operation conditions, and thus not well applied to the industry. U.S. Pat. No. 6,022,268 (Rodel company, 2000) discloses a polishing pad comprising a plurality of hydrophilic polishing layers without intrinsic ability to absorb or transport a plurality of slurry particles, wherein a polishing surface of each polishing layer has a random surface topography and a macro-texture produced by solidifying a flowable material. The polishing layers are manufactured by solidifying without cutting the pad from a larger material, and applying at least a portion of a macro-texture onto the polishing surface without cutting or skiving of the polishing surface according to this patent. In view of the examples of this patent, it can be appreciated that the used formulation and molding conditions are as same as those of U.S. Pat. No. 5,578,362 except utilizing injection molding into a mold having the final dimensions and groove design of the desired pad. This patent effectively improves the macro-defects at the polishing surface due to cutting and polishing performance, but the disadvantages such as time-consuming for production and the like still exist in this patent. U.S. Pat. No. 6,239,188 (Fuji Spinning company, 2001) discloses a urethane molded product of a polishing pad with improved polishing flatness and improved polishing rate obtained by adding expanded microballoons having two sizes of 10 to 50 μm and 80 to 100 μm in a weight ratio within a specific range to an isocyanate-terminated urethane prepolymer and an active hydrogen-containing compound, and then curing the mixture. Even though this patent can improve flatness of a polished article that can not be obtained by the prior art in which only one type of the microballoons is used, it also retains the problems, such as requirements for heating temperature higher than normal temperature and prolonged curing time, which are detrimental to industrial application.

Therefore, the problem to be solved is to provide a polishing pad with stable, excellent and faster fabricating polishing properties.

### SUMMARY OF INVENTION

An objective of the present invention is to provide a method for manufacturing a highly-planar auxiliary gas-adding PU polishing pad with homogeneous cell in a reaction injection molding manner under high pressure.

Another objective of the present invention is to provide a PU polishing pad for use to polish surfaces of highly precise objects, such as semiconductor wafers, metallurgical samples, memory discs, optical components, lenses, wafer masks and the like.

In accordance with the above and other objectives, the present invention proposes a method for manufacturing an auxiliary gas-adding PU polishing pad. By adding auxiliary gas in certain volume percentage to resins containing active hydrogen functional groups, followed by mixing with an inorganic/organic chemical/physical foaming agent and resins containing —NCO functional groups in a specific ratio, the mixture is reaction injection-molded at normal temperature and high pressure to obtain highly-planar auxiliary gas-adding PU polishing pads with uniform pores.

### BRIEF DESCRIPTION OF DRAWINGS

The present invention can be more fully understood by reading the following detailed description of the preferred embodiments, with reference made to the accompanying drawings, wherein:

FIG. 1 is a photograph of SEM (scanning electronic microscope) showing bubble continuity and uniformity in Example 2 in magnification of 100 times; and

FIG. 2 is a photograph of SEM showing bubble continuity and uniformity in Example 3 in magnification of 100 times.

### DETAILED DESCRIPTION

A method for manufacturing an auxiliary gas-adding PU polishing pad according to the present invention, utilizes aliphatic or aromatic isocyanate resins containing —NCO functional groups as raw materials, which are uniformly mixed with resins containing active hydrogen functional groups selected from polyol resins containing —OH functional groups, polyamine resins containing NH functional groups, and polythiol resins containing SH functional group, accompanied with additives selected from chain extenders, foaming agents, foam stabilizers, catalysts, and auxiliary gases selected from air, nitrogen, inert gases, under high pressure, and then injected into a mold to form microcellular PU polishing pad.

The above-fabricated PU polishing pad has adequate strength and flexibility. After foaming, pores in effective polishing portions of the PU polishing pad are uniformly sized and distributed, and mostly surface-processed to form open cells.

The manufacture method according to the invention is implemented in a batch manner. First, a resin containing OH functional groups is added and mixed with additives such as a chain extender of 5 to 30 wt. % (preferably 10 to 20 wt. %), a foaming agent of 0.1 to 10 wt. %, a foam stabilizer of 0.1 to 10 wt. %, a catalyst of 0.1 to 1.0 wt. % etc., and an auxiliary gas of 5 to 30 vol. % (preferably 10 to 15 vol. %). The auxiliary gas is selected from air, nitrogen, and inert gases. Then, a resin containing NCO functional groups such as prepolymerized isocyanates is added, and the mixture of the resin containing NCO functional groups and the resin containing OH functional group is adjusted with its index (ratio) of NCO to OH to be in a range between 0.6 and 1.5, preferably between 0.95 and 1.1. Under temperature of 20 to 100° C. (preferably 20 to 60° C.) and pressure of 2 to 20 MPa (preferably 5 to 20 MPa), the mixture is reaction-injected into a mold and quickly foamed to form a single PU polishing pad with a polyurethane structure. Experiments show that, the polishing pad can be shaped and removed from the mold within 3 to 5 minutes.

In the manufacture method according to the invention, formulas of polyol resins can be modulated optionally to obtain different hardness, density, elongation and strength for a flexible PU polishing pad with uniform continuous open cells. Besides, with proper mold design and formula modulation of resins containing active hydrogen, single pieces of symmetric foamed PU products can be obtained by the manufacture method according to the invention; such a symmetric foamed PU product is not foamed at surfaces thereof, but formed with continuous symmetric pores gradually away from the surfaces. Each single piece of the symmetric foamed PU product can be cut symmetrically in the middle to form two pieces of dual-layer PU structure, including a relatively more rigid surface layer and a relatively softer buffer layer beneath the surface layer. The rigid surface layer provides the PU polishing pad with better planarity for polishing wafers, and the soft buffer layer provides the PU polishing pad with better uniformity during polishing in facility with foaming agents and auxiliary gases.

The single-piece auxiliary gas-adding PU polishing pad, fabricated by high-pressure reaction injection molding according to the invention, can be subjected to fine surface treatment to obtain single-layer combined structure of a foamed PU product and a pressure-sensitive tape. This type of polishing pad has appropriate surface hardness to maintain preferable planarity and quality, and surfaces of the polishing pad can properly deform along with chip curvature, so as to achieve better polishing uniformity.

Polyisocyanate oligomers suitably used in the invention include aliphatic and aromatic isocyanate monomers, and various mixing ratios of 4,4′ and 2′,4 polyisocyanate resins with different functional groups. Specific examples of isocyanate monomers are toluene diisocyanate, triphenylmethane-4,4′,4″″-triisocyanate, benzene-1,3,5-triisocyanate, hexamethylene diisocyanate, xylene diisocyanate, chlorophenylene diisocyanate, dicyclohexylmethane-4,4′-diisocyanate, and methylenebisdiphenyl diisocyanate.

Resins containing active hydrogen suitably used in the invention include polyether polyols, polyester polyols, polycaprolactones, polyamine resins, polythiol resins, and combinations thereof. Specific examples of polyol resins are polypropylene oxide ether polyols (PPG), polymer polyols (copolymer of styrene and acrylonitrile), polyolefin polyols (synthesized from polybutadiene), copolymerized ether polyols, polyether polyamines, and polytetramethylene oxide polyols (PTMEG).

Specific examples of chain extender suitably used in the invention include 1,4-butanediol, ethylene glycol, propylene glycol, glycerin, 4,4′-methylene-bis-(3-chloro-2,6-ethylaniline), triethanolamine, tri-isopropanolamine, and aromatic and aliphatic polyamines. The chain extender is typically added in an amount of 5 to 30 wt. %, preferably 10 to 20 wt. %.

Foaming agents suitably used in the invention include inorganic foaming agents and organic foaming agents. Specific examples of the inorganic foaming agents are water and carbon dioxide; specific examples of the organic foaming agents are propane, butane, pentane, acetone, methylene dichloride, hydrochlorofluorocarbon compound (e.g. HCFC-22, HCFC-141b, etc), or hydrofluorocarbon compound (e.g. HFC-134a, HFC-365mfc, HFC-227ea, HFC-245fa), and the like.

Foam stabilizers suitably used in the invention include siloxanized compound, ethylene oxidized polyols, or mixtures thereof. Specific examples of the foam stabilizers are ethylene oxidized polymeric polyols, siloxanized ethylene oxide, and propane-cografted compound.

The present invention is further described in detail with reference to the following examples that do not limit the scope of the invention.

### EXAMPLE 1

EXAMPLE 1

| Formula | wt. % |
|---|---|
| Polymer polyol (Mw = 6000) | 79 |
| 1,4-butanediol | 21 |
| Organic amine catalyst | 0.46 |
| Water | 0.2 |
| Siloxane foam stabilizer | 1.0 |
| MDI isocyanate prepolymer (NCO = 23%) | 50 |

In Example 1, raw materials are used at 32° C., and incorporated with air of 8 vol. %. Mold temperature is 50° C., and operation pressure of a reaction injection-molding machine is 15 MPa. By the above formula and conditions, physical properties of fabricated products are measured as follows.

| | |
|---|---|
| Tensile strength (MPa) | 15 |
| Elongation (%) | 120 |
| Hardness (shore-D) | 55 |
| Density (g/cm³) | 0.78 |
| Compressibility (%) | 1.02 |

### EXAMPLE 2

| Formula | wt. % |
|---|---|
| Polyester polyol (Mw = 1000) | 84 |
| Ethylene glycol | 16 |
| Organic amine catalyst | 1.0 |
| Water | 0.2 |
| Siloxane foam stabilizer | 1.0 |
| MDI isocyanate prepolymer (NCO = 29.5%) | 100 |

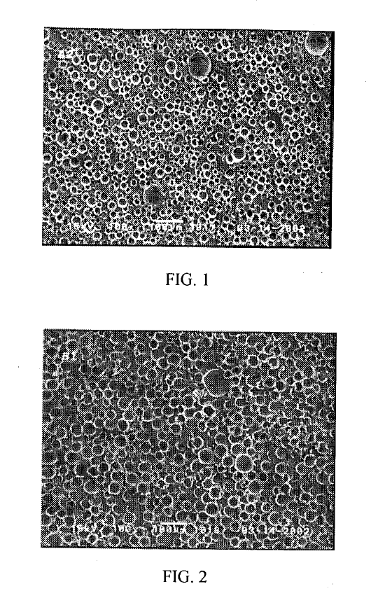

In Example 2, raw materials are used at 55° C., and incorporated with air of 12 vol. %. Mold temperature is 60° C., and operation pressure of a reaction injection-molding machine is 15 MPa. Bubble continuity and uniformity can be well observed through the use of a scanning electronic microscope (SEM), as shown in FIG. 1. By the above formula and conditions, physical properties of fabricated products are measured as follows.

| | |
|---|---|
| Tensile strength (MPa) | 19 |
| Elongation (%) | 180 |
| Hardness (shore-D) | 60 |
| Density (g/cm³) | 0.7 |
| Compressibility (%) | 0.98 |

### EXAMPLE 3

| Formula | wt % |
|---|---|
| Polycaprolactone polyester (Mw = 1000) | 84 |
| Ethylene glycol | 16 |
| Organic amine catalyst | 0.45 |
| Pentane | 6 |
| Siloxane foam stabilizer | 1.0 |
| MDI isocyanate prepolymer (NCO = 28%) | 100 |

In Example 3, raw materials are used at 50° C., and incorporated with air of 15 vol. %. Mold temperature is 60° C., and operation pressure of a reaction injection-molding machine is 15 MPa. Bubble continuity and uniformity can be well observed, as shown in FIG. 2. By the above formula and conditions, physical properties of fabricated products are measured as follows.

| | |
|---|---|
| Tensile strength (MPa) | 17.8 |
| Elongation (%) | 156 |
| Hardness (shore-D) | 58 |
| Density (g/cm³) | 0.7 |
| Compressibility (%) | 1.01 |

In the above examples, by using various chain extender, amount of foaming agent and injected amount into a metallic mold, different density and hardness can be obtained as well as physical properties and parameters can be further modulated for the fabricated PU polishing pad.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A method for manufacturing an auxiliary gas-adding polyurethane (PU) and polyurethane-urea (PUR) polishing pad, comprising the steps of:
(a) adding and mixing a resin containing active hydrogen functional groups with additives and an auxiliary gas, as well as a resin containing —NCO functional groups, and
(b) injecting and foaming the mixture of step (a) in a mold to produce a micro porous PU polishing pad.

2. The method of claim 1, wherein the resin containing active hydrogen functional groups is selected from polyol resins, polyamine resins, and polythiol resins.

3. The method of claim 1, wherein the additives comprises a chain extender, a foaming agent, a foam stabilizer, and a catalyst.

4. The method of claim 1, wherein the auxiliary gas is selected from air, nitrogen, and insert gases.

5. The method of claim 1, wherein the resin containing —NCO functional groups is selected from aliphatic isocyanate resins, and aromatic isocyanate resins.

6. A PU polishing pad fabricated by the method of claim 1, has bulk density of 0.3 to 0.9 g/cm³, hardness of 30 to 80 shore-D, and pore size of 5 to 80 μm.

7. The PU polishing pad of claim 6, wherein the polishing pad is used to polish objects including semiconductor wafers, metallurgical samples, memory-disc surfaces, optical components, lenses and wafer masks.

8. A method for manufacturing an auxiliary gas-adding polyurethane (PU) and polyurethane-urea (PUR) polishing pad, comprising the steps of:
(a) adding and mixing a resin containing —OH functional groups with additives and an auxiliary gas, as well as a resin containing —NCO functional groups, adjusting index of —NCO to —OH for mixture of the resin containing —NCO functional groups and the resin containing —OH functional groups to be in a range between 0.6 and 1.5; and
(b) injecting and foaming the mixture of step (a) in a mold to produce a PU/PUR polishing pad.

9. The method of claim 8, wherein the resin containing OH functional groups is a polyol resin.

10. The method of claim 8, wherein the additives comprises a chain extender of 5 to 30 wt. %, a foaming agent of 0.1 to 10 wt. %, a foam stabilizer of 0.1 to 10 wt. %, and a catalyst of 0.1 to 10 wt. %.

11. The method of claim 8, wherein the auxiliary gas is selected from air, nitrogen, and insert gases.

12. The method of claim 8, wherein the resin containing —NCO functional groups is selected from aliphatic isocyanate resins, and aromatic isocyanate resins.

13. The method of claim 8, wherein the index of —NCO to —OH is in a range between 0.95 and 1.1.

14. A PU polishing pad fabricated by the method of claim 8, has bulk density of 0.3 to 0.9 g/cm³, hardness of 30 to 80 shore-D, and pore size of 5 to 80 μm.

15. The PU polishing pad of claim 15, wherein the polishing pad is used to polish objects including semiconductor wafers, metallurgical samples, memory-disc surfaces, optical components, lenses and wafer masks.

16. A method for manufacturing an auxiliary gas-adding polyurethane (PU) and polyurethane-urea (PUR) polishing pad, comprising the steps of:
(a) adding and mixing polyol resins with a chain extender of 5 to 30 wt. %, a foaming agent of 0.1 to 10 wt. %, a foam stabilizer of 0.1 to 10 wt. %, a catalyst of 0.1 to 1.0 wt. % and an auxiliary gas of 5 to 30 vol. %, and adjusting index of NCO to OH for mixture of prepolymerized isocyanate resins and the polyol resins to be in a range between 0.6 and 1.5; and
(b) injection reacting and foaming the mixture of step (a) in a mold to produce a PU polishing pad at a temperature of 20 to 100° C. and under a pressure of 2 to 20 MPa.

17. The method of claim 16, wherein the auxiliary gas is added in an amount of 10 to 15 vol. %.

18. The method of claim 16, wherein the chain extender is added in an amount of 10 to 20 wt. %.

19. The method of claim 16, wherein the temperature is from 20 to 60° C.

20. The method of claim 16, wherein the pressure is from 5 to 20 MPa.

21. The method of claim 16, wherein the polyol resin is selected from polyether polyols, polyester polyols, polycaprolactones, polyamine resins, polythiol resins and combinations thereof.

22. The method of claim 16, wherein the prepolymerized isocyanate resin is selected from aliphatic and aromatic isocyanate monomers, and 4,4′ and 2′,4 isocyanate resins having 2 to 4 functional groups in various mixing ratios, and combinations thereof.

23. The method of claim 16, wherein the index of NCO to OH is in a range between 0.95 and 1.1.

24. The method of claim 16, wherein the foaming agent is an inorganic foaming agent.

25. The method of claim 24, wherein the inorganic foaming agent is water or carbon dioxide.

26. The method of claim 16, wherein the foaming agent is an organic foaming agent.

27. The method of claim 26, wherein the organic foaming agent is selected from the group consisting of propane, butane, pentane, acetone, methylene dichloride, hydrochlorofluorocarbon compound, and hydrofluorocarbon compound.

28. The method of claim 27, wherein the hydrochlorofluorocarbon compound is selected from the group consisting of HCFC-22 and HCFC-141b.

29. The method of claim 27, wherein the hydrofluorocarbon compound is selected from the group consisting of HFC-134a, HFC-365mfc, HFC-227ea and HFC-245fa.

30. The method of claim 16, wherein the foam stabilizer is selected from the group consisting of siloxanized compound, ethylene oxidized polyols, and combinations thereof.

31. A PU polishing pad fabricated by the method of claim 16, has bulk density of 0.3 to 0.9 g/cm³, hardness of 30 to 80 shore-D, and pore size of 5 to 80 μm.

32. The PU polishing pad of claim 31, wherein the polishing pad is used to polish objects including semiconductor wafers, metallurgical samples, memory-disc surfaces, optical components, lenses and wafer masks.
